(19) United States
(12) Patent Application Publication
(10) Pub. No.: US 2009/0263311 A1
(43) Pub. Date: Oct. 22, 2009

(54) METHOD OF REMOVING IMPURITIES FROM SOLIDS

(76) Inventor: CHANG H. LEE, Ghaziabad (IN)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/104,713

(22) Filed: Apr. 17, 2008

(51) Int. Cl. B01D 15/36; C01B 31/02

(52) U.S. Cl. 423/461; 210/660; 210/661

(57) ABSTRACT

The invention relates to a method of removing impurities from solids comprising forming a solid solution, passing the solid solution through an ion exchanger such that at least some impurities present in the solid solution are retained by the ion exchanger, and recovering the solid solution from the ion exchanger.

### CROSS-REFERENCE TO RELATED APPLICATIONS

This application claims the benefit of Indian Patent Application No. 857/Del/2007 filed on Apr. 19, 2007.

### DESCRIPTION OF RELATED ART

Various materials and elements required in industry are in, or required in solid form and contain contaminants and impurities. Purification of solids to remove impurities is a complex and often expensive process, though is often essential in order to meet the standards required of their end use. Moreover, various industrial processes also require separation of mixtures and recovery of precious substances in catalysis of chemical reactions. Carbon is one such solid used in industry and the invention shall be explained with reference to the removal of impurities or purification of carbon, as an example.

Even if origin of the impurities is determined, removal or prevention of the same is not always practically possible. This is often on account of the cost of treatment that render the process not economically feasible, or sometimes due to lack of adequate treating technology. Though separation or classification to remove or reduce impurities in solids such as carbon has been done using air or dry systems, these methods often results in imperfections or inconsistency in the treated carbon.

Purification of carbon involves removal or separation of impurities that mostly come from raw materials such as feedstock, catalysts, additives, water; and process metallurgy such as rusts and scales. Impurities originate from diverse causes including raw materials and/or manufacturing conditions. The feedstock is a typical source of impurities, for example fluid catalytic cracker (FCC) oil used in the manufacture of furnace carbon black may contain catalysts used in the refinery which remain in carbon.

Carbon is generally characterized by the fact that its majority is elemental carbon, C12 which amounts for over 99.9 wt. %. However, sometimes the content of elemental carbon is much lower, which results in the deterioration of value of the final industrial product. Moreover, it is often imperative to purify or increase the content of elemental carbon in order to meet the standards and requirements of an application. For example, physical strength such as modulus, tensile strength, and elongation; and functional properties such as color shade, darkness, undertone, chromaticity, electric and thermal conductivity, UV protection, EMI shielding, electrostatic charge dissipation, reinforcement, and catalysis; service life; and so forth are effected by a decrease in the content of elemental carbon and the presence of impurities.

Impurities in solids, such as carbon include for example H⁺, Li⁺, Na⁺, K⁺, NH4⁺, Rb⁺, Cs⁺, Ag⁺, Ti⁺, Ba²⁺, Ni²⁺, Fe²⁺, Fe³⁺, Ca²⁺, Mg²⁺, Zn²⁺, Co²⁺, Cu²⁺, Sr²⁺, Pb²⁺, Cd²⁺, OH—, I—, NO₃₋, HSO₄₋, HSO₃₋,BrO₃₋, ClO₃₋, HCO₃₋, HSiO₃₋, BI—, CN—, NO₂₋, CL−, IO₃₋, F—, formate, benzene, sulphonate, salicylate, acetate, propionate, citrate, and phenate.

Ion exchangers or the principle of using ion exchange has been predominantly used in the water industry to purify or separate unwanted ions out of water for specific purposes, such as drinking, or for pharmaceutical, chemical, atomic and co-generation plant applications. In addition, ion exchange has also been used in other industries for varied purposes, for example, absorption of specific ions, acid purification, acid retardation, acid removal for corrosion control, sugar processing, beverage processing, catalysis of organic reactions, caustic purification, chromatographic separations, condensate polishing, demineralization, fine chemicals synthesis, formic acid removal from formaldehyde, inhibitor and stabilizer removal, ion retardation, metals control, mineral processing, mining, radium removal from ground water, salts removal, trace contaminant removal, and ultra-pure chemicals production.

The principle of ion exchange has so far not been applied for the removal of impurities or the purification of solids. Moreover, the principle of ion exchange has not been applied for the removal of impurities or purification of carbon.

### SUMMARY OF THE INVENTION

The invention provides for a method and system for removing impurities from solids using ion exchange.

The invention relates to a method of removing impurities from solids in which a solution with the solid is formed, the solution is passed through an ion exchanger such that at least some impurities present in the solution are retained by the ion exchanger, and the solution is recovered from the ion exchanger. The solution so recovered from the ion exchanger may be filtered and dried to obtain solids from which at least some impurities have been removed.

The invention also provides for a system for ion exchange containing ionic elements including functional ionic resin or resins; and furnished with accessories and parts that enables the solid solution to disperse homogeneously throughout the ionic elements or resins.

### BRIEF DESCRIPTION OF THE DRAWINGS

The accompanying drawing illustrates an embodiment of the invention and together with the following detailed description serves to explain the principles of the invention.

FIG. 1 illustrates a system for removing impurities in solids in accordance with embodiments of the invention.

### DETAILED DESCRIPTION OF PREFERRED EMBODIMENTS

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. The invention has been explained for a method of removing impurities from carbon, but as would be obvious to a person in the art, the invention may be applied to any solid.

The invention relates to the removal of impurities from solids and has been described for the removal of impurities from carbon as an example. In particular the invention describes a method and system for the removal of impurities from solids using ion exchange. The impurities are removed by first forming a solution of the solid. The solid solution is then passed through an ion exchange system where the impurities are retained. The solution enables a better contact of impurities present in solids with resins of an ion exchange system.

A solution as referred to herein includes any suspension, colloid, slurry formed by mixing the solid with a suitable liquid medium. The solution may be formed with or without the aid of chemicals.

The invention is applicable to all solids. In the present example, the invention is applicable to any carbon type, including carbons required in different industries, such as amorphous carbon black, by-product carbon, carbon fiber, carbon fibril, single wall nanotube (SWNT), multiple wall nanotube (MWNT), natural graphite, artificial graphite, graphitized amorphous carbon, activated carbon, artificial diamond, bone-black, pyro-black recovered from scrap tires, and fly-ash carbon. The different carbon types are manufactured by various processes, for example furnace process, channel process, gas process, thermal process, acetylene process, plasma process, and other petrochemical process.

A solid solution is formed by mixing the solid with any suitable liquid and preferably also includes a dispersion aid. A dispersion aid may be any one or a combination of an acid, base, alcohol, acetate, anionic surfactant or non-ionic surfactant. A non ionic surfactant is preferably used as a dispersion aid.

Preferably the liquid used for forming the solid solution is water. The water may be raw water or de-mineralized water, though it is preferable to use de-mineralized water.

The ratio of solid in the solution is preferably in the range of 0.5 to 10 wt. %. It is however possible to work the invention at larger solid ratios.

The solid solution is formed by adding the solid to a liquid along with the dispersing aid and mixing the same thoroughly to create a homogeneous solution. For example, 2 kg of carbon black, N330 as per ASTM D1765, is mixed with 40 gallons of water along with a non ionic surfactant and mixed using a high shearing impeller mixer for 30 minutes at 800 rpm.

The solid solution so formed is capable of dispersing more completely in the ionic element bed of the ion exchanger and thus ensures a better removal of impurities. Forming of the solid solution also improves the contact between the ionic elements in the ion exchanger such as resins and the impurities present in the solids.

A solid solution so formed is passed through an ion exchanger. To achieve a better mixing of the solid solution with the ionic elements of the ion exchanger it is preferable to create a tangential, helical spiral or agitated flow of the solid solution within the ion exchanger. This tangential, helical, spiral or agitated flow of the solid solution within the ion exchanger may be created in various ways with or without the use of compressed air or by using any suitable means. For example, the tangential flow may be created by introducing the solid solution from the sides of the ion exchanger. Alternatively, the tangential helical, spiral or agitated flow may be created by introducing the solid solution from the sides of the ion exchanger and introducing compressed air from the bottom. The air so introduced will enter the ion exchanger through one or more distributors with a profile cut on it that creates a spiral flow. This profile is preferably helical.

It is equally within the scope of the invention, that the compressed air is introduced from the sides of the ion exchanger and the solid solution is introduced from the bottom. The solid solution will enter the ion exchanger through one or more distributors with a profile cut, preferably helical, that in combination with the compressed air creates a spiral flow.

In another embodiment, both solid solution and compressed air are introduced from the bottom and enter the ion exchanger through one or more distributors with a profile cut, preferably helical, that creates a spiral flow.

In accordance with an embodiment of the invention, it is preferable that the ion exchanger be vertically mounted and it is also preferable that the solid solution enters the ion exchanger from the bottom and exits from the top. This is to prevent blocking of voids in resin bed of ion exchanger.

The solid solution after passing over the ionic elements where impurities present in the solution react with the ionic elements and are held within the ionic element bed is recovered from the ion exchanger. In accordance with the preferred embodiment, the solid solution is recovered from the top end of the ion exchanger. On account of various parameters including level of dispersion of the solid in the solution and that of the solid solution within the ion exchanger, as also on the species and/or the density of the solid and the type of ionic element or resin beads, some ionic element or resin is also discharged from the ion exchanger. Under ideal operating conditions, it is desired that only the solid solution devoid of any ionic element or resin is discharged from the ion exchanger.

To minimize the discharge of ionic elements or resins from the ion exchanger the solid solution is first preferably passed through a mesh before exiting the ion exchanger. The mesh is so sized that it would retain most of the resin beads within the exchanger. A standard mesh of size 60 to 100 may be used depending on the size and type of resin.

The discharge of ionic elements or resins from the ion exchanger may also be minimized by controlling the rate of flow of the solid solution through the exchanger. A faster rate of flow causes more resins to exit the exchanger.

Carbon, treated in accordance with the teachings of the invention has been found to have reduced amount of ash and extractable elements and can be shipped in the form of wet powder or dry beads after pelletizing. The carbon solution recovered may be treated by conventional methods of filtering and drying.

In accordance with an embodiment of the invention, the carbon solution recovered from the ion exchanger may be sent to at least one other ion exchanger. Depending on the requirements, a plurality of ion exchangers may be connected in series such that solid solution discharged from one is fed to another. The ion exchangers so connected may be cationic, ionic, or mixed bed.

In accordance with an embodiment of the invention, the carbon solution recovered from an ion exchanger is fed back into the same ion exchanger for a desired number of cycles, till the required level of purity is achieved. In between two cycles, the carbon solution may be stored in a storage medium while the ion exchanger is regenerated.

To more fully illustrate the present invention, the following non-limiting examples are presented.

### EXAMPLE 1

The 2 kg of Carbon black, N330 per ASTM D11765 is dispersed in 40 gallons of water with a non-ionic surfactant for 30 minutes by a high shearing impeller mixer at 1800 rpm. The resulting carbon solution is fed to the ion exchanger containing cationic resin of sulfonic acid. The carbon solution enters the ion exchanger from two side inlets (6), as illustrated in FIG. 17 in a tangential flow along the shell of the ion exchanger. Simultaneously, compressed air enters the exchanger by inlet (1) and distributor (7) at a predetermined rate, such as 100 liter per minute. The flow rate of carbon solution and the compressed air is adjusted such that the flow of resin beads through the discharge port (3) on the top of the ion exchanger is minimized or preferably eliminated. The distributor has helical slits such that it brings about a whirl and bubbles upwards to scatter the particles of carbon and impurities through resin bed. The air is discharged through outlet (5) at the top end of the ion exchanger. Carbon solution is recovered from discharge port (3). The ash content, by ASTM D1506 Method A, on the recovered carbon improved 99% compared to the untreated.

The carbon solution recovered from the ion exchanger may be sent to a resin recovery system in which resins or ionic elements discharged along with the carbon solution are recovered and fed back to the ion exchanger by port (8).

### EXAMPLE 2

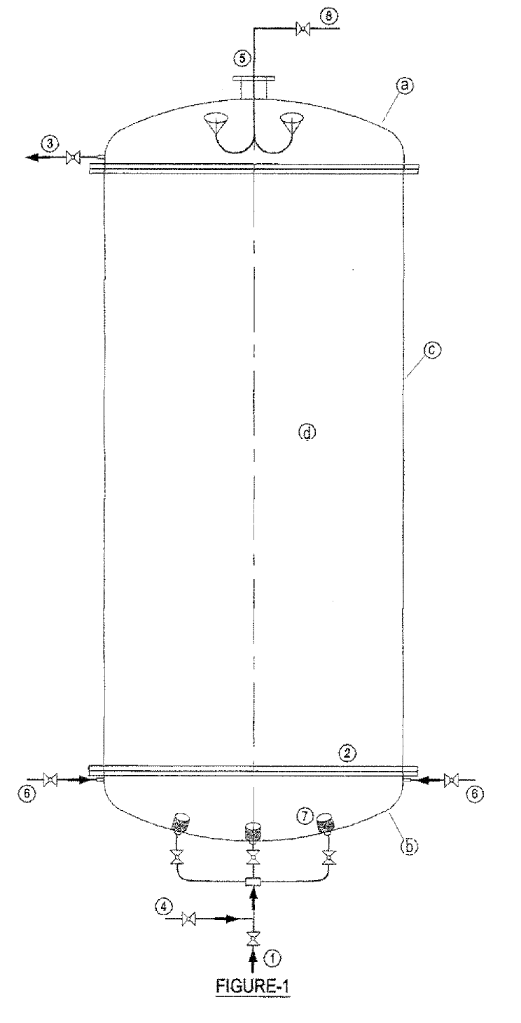

A carbon solution is prepared as described in example 1 above. With reference to FIG. 1, the carbon solution is fed to the ion exchanger from inlet port (l) and distributor (7). Simultaneously, compressed air is introduced into the exchanger through the two ports (6) at a predetermined rate, such as 100 liter per minute, in tangential flow. The flow so created results in the carbon solution passing through the resin bed of the ion exchanger in a distributed manner. The air is discharged by outlet (5) at the top end of the ion exchanger. The carbon solution is recovered from the discharge port (3) and the ash content, by ASTM D1506 Method A, on the recovered carbon solution improved 99% compared to the untreated.

Similarly, both the solid solution and the compressed air can enter from the bottom of the ion exchanger through ports (1) and (4) and the distributors will create the necessary tangential or helical flow of the carbon solution through the resin bed.

1. A method of removing impurities from solids comprising forming a solid solution, passing the solid solution through an ion exchanger such that at least some impurities present in the solid solution are retained by the ion exchanger, and recovering the solid solution from the ion exchanger.

2. A method as claimed in claim 1 wherein concentration of the solids in the solution is in the range of 0.5 to 10 wt. %.

3. A method as claimed in claim 1 wherein the ion exchanger is vertically mounted and the solid solution is introduced into the ion exchanger at the bottom and discharged from the top.

4. A method as claimed in claim 1 or wherein passing the solid solution through ion exchanger includes passing compressed air through the ion exchanger.

5. A method as claimed in claim 1 wherein the solid solution enters or passes through the ion exchanger in at least one of a tangential, helical, spiral or agitated flow.

6. A method as claimed in claim 1 wherein the solid solution recovered from the ion exchanger is passed through at least one other ion exchanger.

7. The method as claimed in claim 1 wherein the ion exchanger contains one of cationic resin, anionic resin, or their mixture.

8. A method as claimed in claim 6 wherein the solid solution recovered is passed through at least two more ion exchangers wherein the solid solution flows from one ion exchanger to another in the serial order of cationic, anionic, and mixed bed exchanger.

9. A method as claimed in claim 1 wherein the solid solution passes through a screen before recovery from ion exchanger.

10. A method as claimed in claim 1 wherein the solution recovered from the exchanger is passed through an ion recovery system in which at least some of the ions coming out of the ion exchanger with the solid solution are recovered.

11. A method as claimed in claim 1 wherein solution recovered from the ion exchanger is fed back into the ion exchanger in a recycling operation for a predetermined number of cycles.

12. A method as claimed in claim 11 wherein the recycling operation comprises passing the solution recovered into a disperser between the charging and discharging the ion exchanger.

13. A method as claimed in claim 1 wherein the solid is carbon.

14. A method of removing impurities from carbon comprising forming a carbon solution, passing the carbon solution through an ion exchanger such that at least some impurities present in the carbon solution are retained by the ion exchanger, and recovering the carbon solution from the ion exchanger.

15-16. (canceled)
